(19) United States
(12) Patent Application Publication
(10) Pub. No.: US 2003/0024751 A1
(43) Pub. Date: Feb. 6, 2003

(54) Reversible wear bar

(76) Inventor: Jean-Pierre Lebreux, Saint-Georges (CA)

Correspondence Address: MCDERMOTT WILL & EMERY, 600 13TH STREET, N.W., WASHINGTON, DC, 20005-3096, US

(21) Appl. No.: 10/199,469

(22) Filed: Jul. 22, 2002

(30) Foreign Application Priority Data
Jul. 23, 2001 (CA) 2,354,201

(51) Int. Cl. B62M 27/02; B62M 29/00

(52) U.S. Cl. 180/182

(57) ABSTRACT

A reversible wear bar for a snowmobile steering ski, comprising a central mounting plate having front and rear ends selectively bendable upwardly and downwardly, top and bottom faces both adapted to extend underneath the snowmobile ski, and opposite lateral sides extending substantially in parallel with each other between the front and rear ends. The mounting plate is provided with elements for fastening the plate under the snowmobile steering ski in alignment therewith with a desired one of the top and bottom faces directed toward the snowmobile steering ski. Two blade members extend respectively on the lateral sides of the central mounting plate. The blade members have similar portions projecting above and below the central mounting plate and provide parallel bearing edges on both faces of the central mounting plate.

### FIELD OF THE INVENTION

The present invention relates to snowmobiles, and more particularly to a reversible wear bar for a snowmobile steering ski.

### BACKGROUND

Snowmobile are usually provided with a pair of front steering skis sliding on the snow. Under most snow conditions, especially at high speeds, the steering skis, when turned, tend to slide sideways instead of steering the snowmobile as intended.

Certain methods have been proposed to provide increased predictability and control of snowmobile steering skis. One of the most common methods resides in adding a keel or a bar known as a wear bar under the ski as it reduces wear at the level of the ski. The keel bites into the surface of the snow or ice and enhances the steering, particularly at high speeds.

Known in the art are U.S. Design Pat. No. 366,014 (Lindquist et al.), and U.S. Pat. Nos. 3,632,126 (Shorrock), 3,711,109 (Hofbauer), 3,643,978 (Westberg), 5,040,818 (Metheny) and 5,145,201 (Metheny), which illustrate various models of keels.

However, the above-mentioned documents all provide devices which have certain drawbacks. In the case of Shorrock, the weight of both the snowmobile and the user is distributed evenly over the flat surface of the skis. A portion of the weight is transmitted to the ends of the straight keel, which makes the skis difficult to turn and reduces the usefulness of the keel. The biting effect of the keel is also distributed over a large area instead of being concentrated, which is not necessarily efficient. In the case of Hofbauer, the short keel concentrates the weight beneath the steering spindles, but the biting effect is reduced in soft snow due to the short length of the keel. Also, because the keel is hinged, it tends to retract on hard snow or on ice, when it would rather be very important. In the case of Westberg, the keel has a short flange which concentrates the weight beneath the steering spindles, but since the keel is mounted on the edge of the ski, it actually aggravates the problem of the ski “catching” in the snow when turning, possibly causing a loss of control even at moderate speeds. Also, such short keels do not provide steering stability during straight runs and exhibit reduced steering ability in soft snow.

The above documents reveal what has heretofore been a dilemma with respect to the design of snowmobile steering skis. Increased positive steering provided by a long keel comes at the expense of the ease of steering. Conversely, a short keel makes the skis easier to steer, but reduces the amount of positive control. There is a need for a snowmobile steering ski that provides improved controllability and positive turning without a concomitart increase in steering difficulty.

U.S. Pat. No. 6,276,699 (Simmons et al.), U.S. Pat. No. 5,700,020 (Noble), U.S. Pat. No. 6,012,728 (Noble), Canadian Patent No. 2,300,359 (Lachance) and U.S. Design Pat. No. 255,893 (Fritz) also illustrate the state of the art in this field.

However, all of the above devices have some drawbacks, especially their high manufacturing cost and their fast wear.

### SUMMARY

An object of the present invention is to provide a wear bar which has a low manufacturing cost compared to existing wear bars.

Another object of the present invention is to provide such a wear bar having a longer service life.

Another object of the present invention is to provide such a wear bar which is easily mountable onto a snowmobile ski and which is preferably compatible with different attachment models for snowmobile skis.

According to the present invention, there is provided a reversible wear bar for a snowmobile steering ski, comprising a central mounting plate having front and rear ends selectively bendable upwardly and downwardly, top and bottom faces both adapted to extend underneath the snowmobile ski, and opposite lateral sides extending substantially in parallel with each other between the front and rear ends, the mounting plate being provided with means for fastening the plate under the snowmobile steering ski in alignment therewith with a desired one of the top and bottom faces directed toward the snowmobile steering ski; and two blade members extending respectively on the lateral sides of the central mounting plate, the blade members having substantially similar portions projecting above and below the central mounting plate and providing substantially parallel bearing edges on both faces of the central mounting plate.

### BRIEF DESCRIPTION OF THE DRAWINGS

A detailed description of preferred embodiments will be given herein below with reference to the following drawings, in which like numbers refer to like elements;

FIG. 1 is a side view of a reversible wear bar mounted onto a snowmobile ski according to the present invention.

FIG. 2 is a cross-sectional view of a reversible wear bar mounted onto a snowmobile ski according to the present invention taken along the line A-A of FIG. 1.

FIG. 3 is a front view of a reversible wear bar mounted onto a snowmobile ski according to the present invention.

FIG. 4 is a top view of a reversible wear bar according to the present invention.

FIG. 5 is a side view of a central mounting plate of a reversible wear bar according to the present invention.

FIG. 6 is a side view of a reversible wear bar according to the present invention.

FIG. 7 is a perspective view of a reversible wear bar according to the present invention.

### DETAILED DESCRIPTION OF THE PREFERRED EMBODIMENTS

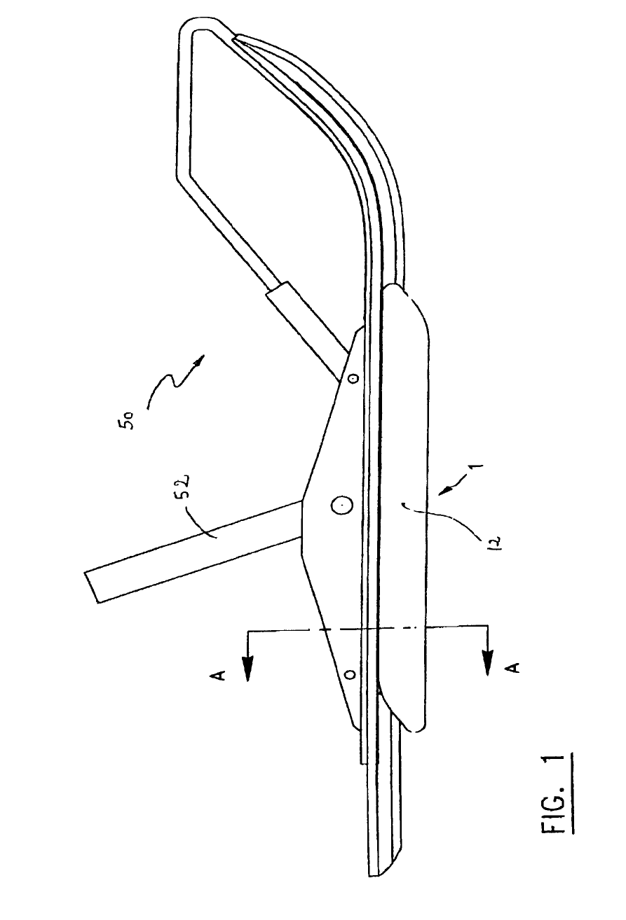

Referring to FIG. 1, there is shown a reversible wear bar 1, according to the present invention, mounted onto a snowmobile ski 50. As illustrated, the reversible wear bar 1 is preferably affixed at the center of the steering ski 50, right under the steering spindle 52 for improved positive steering action.

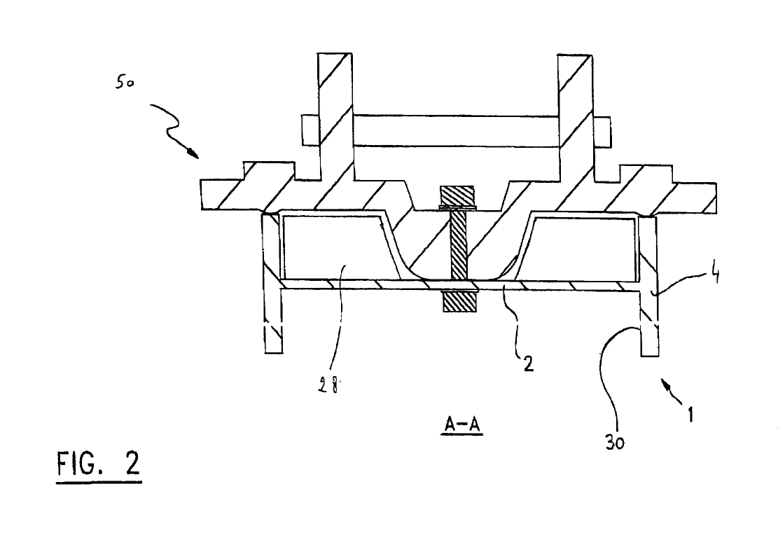

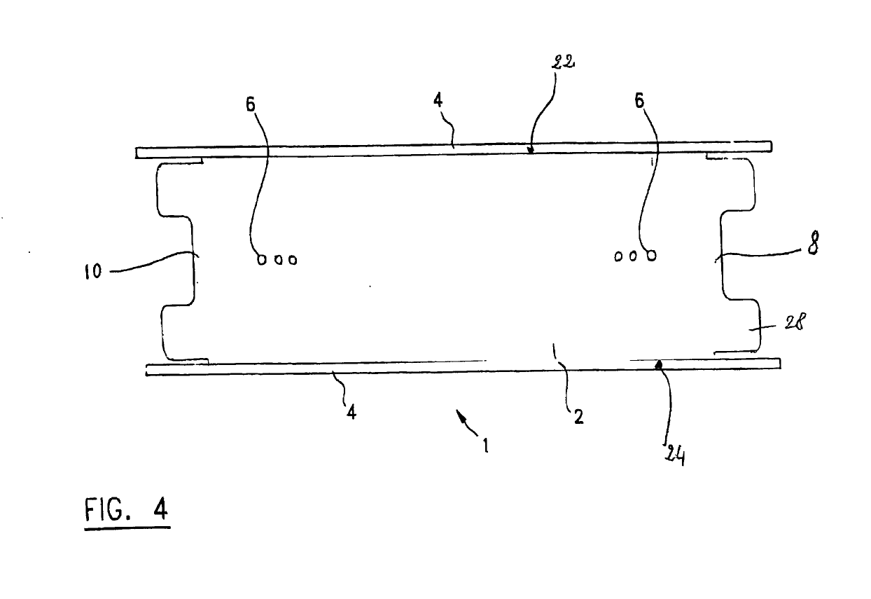

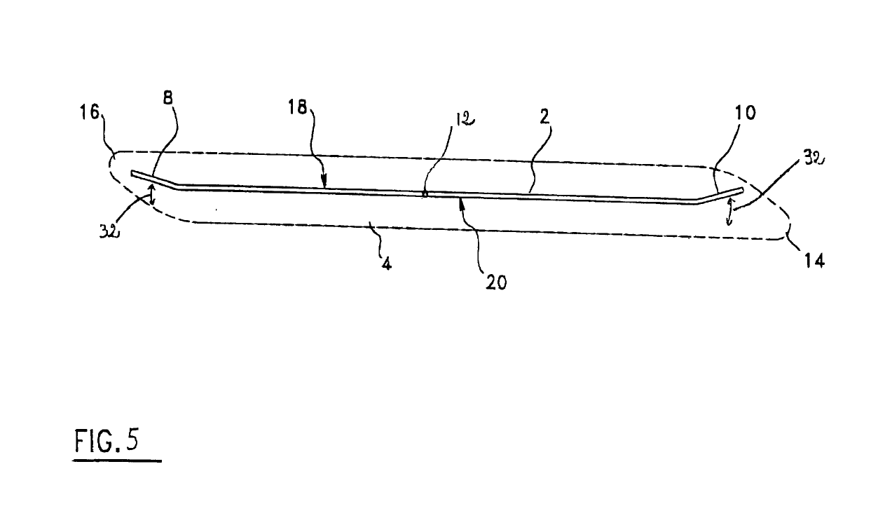

Referring to FIGS. 4, 5 and 7, the reversible wear bar 1 has a central mounting plate 2. The front and rear ends 8, 10 of the mounting plate 2 are selectively bendable upwardly and downwardly, as depicted by arrows 32 in FIG. 5. The top and bottom faces 18, 20, of the mounting plate 2 are both adapted to extend underneath the snowmobile ski 50 (as best seen in FIG. 2). The mounting plate 2 has opposite lateral sides 22, 24 extending in parallel with each other between the front and rear ends 8, 10. The mounting plate 2 is provided with fixation holes 6, or any other suitable elements for fastening the central mounting plate 2 under the snowmobile steering ski in alignment with it with a desired one of the top and bottom faces 18, 20 directed toward the snowmobile steering ski 50. The reversible wear bar 1, has also two blade members 4 extending respectively on the lateral sides 22, 24 of the central mounting plate 2. The blade members 4 have similar portions projecting above and below the central mounting plate 2 and providing parallel bearing edges 26 on both faces of the central mounting plate 2. The blade members 4 and the mounting plate 2 may have similar lengths or, preferably, the blade members 4 extend beyond the front and rear ends 8, 10 of the mounting plate 2. As best seen in FIG. 1, the length of the mounting plate 2 and the blade members 4 is shorter than the snowmobile ski 50 for high biting effect in snow or ice.

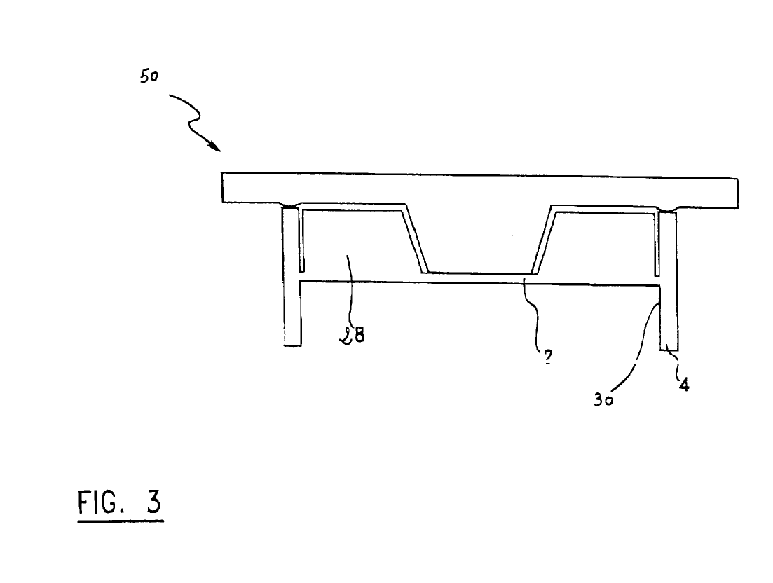

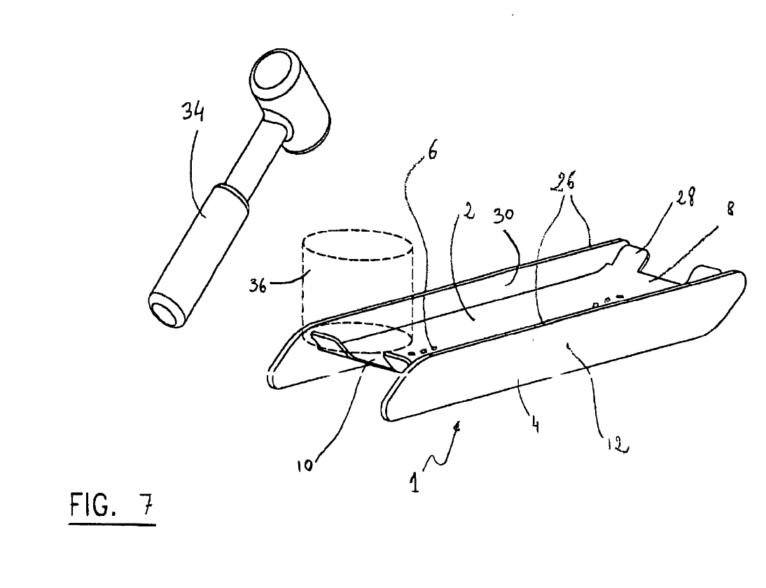

Referring to FIGS. 2, 3 and 7, the front and rear ends 8, 10 of the mounting plate 2 preferably have fork-like shapes with flat prongs 28 extending of inner sides 30 of the blade members 4. As best seen in FIG. 7, the front and rear ends 8, 10 of the mounting plate 2 are preferably initially bent upwardly with respect to the top face 18 of the mounting plate 2. Consequently, the reversible wear bar 1 can be directly mounted onto a snowmobile ski 50, with the front end 8 in the same direction as the front end of the snowmobile steering ski 50. If desired, the reversible wear bar 1 may be provided with initially unbent front and rear ends 8, 10, in which case, the user will have to bend them himself on the side of the mounting plate 2 of his/her choice before use.

Referring back to FIGS. 4 and 7, the lateral sides 22, 24 of the mounting plate 2 have portions extending between the front and rear ends 8, 10 of the mounting plate 2 welded to the blade members 4 for providing a strong assembly. Other convenient ways to assemble the blade members 4 to the mounting plate 2 may also be considered, provided that the resulting assembly is sufficiently strong.

The fixation holes 6 extending through the mounting plate 2 between the top and bottom faces 18, 20 preferably have positions on the mounting plate 2 compatible with different attachment models for the snowmobile steering ski. The reversible wear bar 2 can thus be affixed to the snowmobile steering ski by fasteners, such as bolts and nuts secured through the appropriate holes 6. By virtue of the simple design of the reversible wear bar 2, it is also quite easy to drill new holes if required.

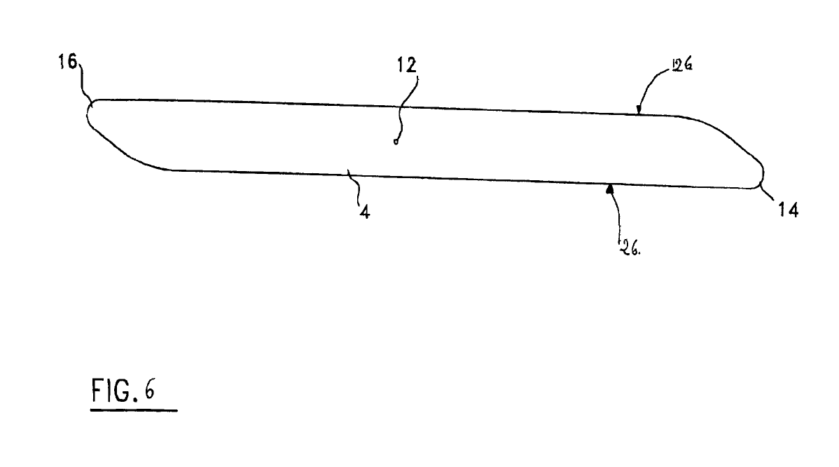

Referring to FIGS. 1, 5 and 6, the blade members 4 may conveniently have front and rear complementary bevelled ends 14, 16 providing the bearing edges 26 with upturned foremost tips as a function of the face of the mounting plate 2 directed toward the snowmobile steering ski. The reversible wear bar 2 must be mounted with the front end 14 of the blade members 4 in the same direction as the front of the snowmobile steering ski 50.

For providing maximum biting effect into snow or ice, the reversible wear bar 1 is preferably centered just beneath the spindle 52 of the steering ski 50 However, the wear bar 1 may be mounted slightly behind of it, if desired. For facilitating the positioning of the reversible wear bar 1 under the snowmobile steering ski 50, one or both blade members 4 may be provided with an alignment mark 12 on their outer side, preferably at a longitudinal center of the blade members 4 for relative alignment with an attachment axis of the snowmobile steering ski 50. The alignment mark 12 may simply be a hole or, for example, a painting mark provided that it is resistant to the hard conditions in which the snowmobile is used.

In order to provide a wear bar 1 which has a long service life, the wear bar 1 is designed to be reversible, that is the blade members 4 providing the bearing edges 26 have initially similar portions projecting above and below the central mounting plate 2. Consequently, in adjusting the front and rear ends 8, 10 of the mounting plate 2 to the snowmobile steering ski, the reversible wear bar 1 can be used on both sides. The blade members 4 and the central mounting plate 2 of the reversible wear bar 1 are can be made of steel, providing a strong structure while being relatively inexpensive. The top and bottom faces 18, 20 of the mounting plate 2 have preferably smooth surfaces and can be provided with Teflon based coatings for enhance sliding of the snow on them.

Typically but not restrictively, the mounting plate 2 and the blade members 4 will have a thickness of about 3/16 inches and a length of about 17 inches. The mounting plate will have a width of about 3½ inches, and the blade members will have a height of about 1½ inches for best performances.

Referring to FIG. 7, once a side of the wear bar 1 is too worn, then the user simply has to reverse it to use the other side. For good biting condition in the snow, the portions of the blade members 4 projecting below the central line of the mounting plate 2 should have a depth of at least 6 mm. Thus, when the blade members 4 wear down to 6 mm of the central mounting plate 2, the reversible wear bar 2 should be dismounted and turned over to use the other side. The front and rear ends 8, 10 of the mounting plate 2 must be adjusted to the shape of the steering ski. Since the front and rear ends 8, 10 of the central plate 2 are not joined to the blade members 4, a user can easily bend them using a hammer 34 and a wooden block 36, as illustrated in FIG. 7. By virtue of its construction, the reversible wear bar 2 fits in minutes over most V-shaped skis.

While embodiments of this invention have been illustrated in the accompanying drawings and described above, it will be evident to those skilled in the art that changes and modifications may be made therein without departing from the essence of this invention. All such modifications or variations are believed to be within the scope of the invention as defined by the claims appended hereto.

1. A reversible wear bar for a snowmobile steering ski, comprising:
a central mounting plate having front and rear ends selectively bendable upwardly and downwardly, top and bottom faces both adapted to extend underneath the snowmobile ski, and opposite lateral sides extending substantially in parallel with each other between the front and rear ends, the mounting plate being provided with means for fastening the plate under the snowmobile steering ski in alignment therewith with a desired one of the top and bottom faces directed toward the snowmobile steering ski; and
two blade members extending respectively on the lateral sides of the central mounting plate, the blade members having substantially similar portions projecting above and below the central mounting plate and providing substantially parallel bearing edges on both faces of the central mounting plate.

2. The reversible wear bar according to claim 1, wherein the blade members and the mounting plate have similar lengths.

3. The reversible wear bar according to claim 2, wherein the blade members extend beyond the front and rear ends of the mounting plate, respectively.

4. The reversible wear bar according to claim 1, wherein the blade members have front and rear complementary bevelled ends providing the bearing edges with upturned foremost tips as a function of the face of the mounting plate directed toward the snowmobile steering ski.

5. The reversible wear bar according to claim 1, wherein the blade members and the mounting plate are made of steel.

6. The reversible wear bar according to claim 1, wherein at least one blade member has an outer side provided with an alignment mark.

7. The reversible wear bar according to claim 1, wherein the means for fastening the mounting plate comprises at least one fixation hole extending through the mounting plate between the top and bottom faces thereof.

8. The reversible wear bar according to claim 7, wherein said at least one fixation hole comprises a plurality of fixation holes having positions or the mounting plate compatible with different attachment models for the snowmobile steering ski.

9. The reversible wear bar according to claim 1, wherein the lateral sides of the mounting plate have portions extending between the front and rear ends of the mounting plate welded to the blade members.

10. The reversible wear bar according to claim 1, wherein the front and rear ends of the mounting plate have fork-like shapes with flat prongs extending on inner sides of the blade members.

11. The reversible wear bar according to claim 1, wherein the front and rear ends of the mounting plate are initially bent upwardly with respect to the top face of the mounting plate.

12. The reversible wear bar according to claim 1, wherein the top and bottom faces of the mounting plate have a smooth surface.

13. The reversible wear bar according to claim 1, wherein the mounting plate and the blade members have lengths substantially shorter than the snowmobile steering ski.

14. The reversible wear bar according to claim 6, wherein the alignment mark substantially extends at a longitudinal center of said at least one blade member for relative alignment with an attachment axis of the snowmobile steering ski.

15. The reversible wear bar according to claim 1, wherein the top and bottom faces of the mounting plate have a Teflon based coating.

16. The reversible wear bar according to claim 1, wherein the mounting plate and the blade members have a thickness of about 3/16 inches and a length of about 17 inches, the mounting plate having a width of about 3½ inches, and the blade members having a height of about 1½ inches.

17. The reversible wear bar according to claim 3, wherein the blade members have front and rear complementary bevelled ends providing the bearing edges with upturned foremost tips as a function of the face of the mounting plate directed toward the snowmobile steering ski, the lateral sides of the mounting plate having portions extending between the front and rear ends of the mounting plate welded to the blade members, the front and rear ends of the mounting plate having fork-like shapes with flat prongs extending on inner sides of the blade members, the front and rear ends of the mounting plate being initially bent upwardly with respect to the top face of the mounting plate.

18. The reversible wear bar according to claim 17, wherein the mounting plate and the blade members have a thickness of about 3/16 inches and a length of about 17 inches, the mounting plate having a width of about 3½ inches, and the blade members having a height of about 1½ inches.

19. The reversible wear bar according to claim 8, wherein the blade members have front and rear complementary bevelled ends providing the bearing edges with upturned foremost tips as a function of the face of the mounting plate directed toward the snowmobile steering ski, the lateral sides of the mounting plate having portions extending between the front and rear ends of the mounting plate welded to the blade members, the front and rear ends of the mounting plate having fork-like shapes with flat prongs extending on inner sides of the blade members, the front and rear ends of the mounting plate being initially bent upwardly with respect to the top face of the mounting plate.
